(19) United States
(12) Patent Application Publication
(10) Pub. No.: US 2014/0109474 A1
(43) Pub. Date: Apr. 24, 2014

(54) Adjustable Plant Support Assembly

(71) Applicant: Joel Richard Reed, JR., Tooele, UT (US)

(72) Inventor: Joel Richard Reed, JR., Tooele, UT (US)

(21) Appl. No.: 13/656,818

(22) Filed: Oct. 22, 2012

(51) Int. Cl. A01G 9/12

(52) U.S. Cl. CPC A01G 9/12
USPC 47/45; 211/207; 211/86.01

(57) ABSTRACT

An adjustable plant support assembly is provided which can be quickly and easily assembled with no tools at all. When disassembled it can be stored in a minimum space, and since there are very few different components it can be manufactured in a simple manner. A plurality of vertical support posts are disposed at the corners of a polygon, e.g. four support posts are disposed at the corners of a rectangle. A plurality of support rods horizontally interconnect the support posts with apertures at the corner angles of the intersecting rods to provide horizontal support. The interconnecting rods can be moved up and down vertically along the vertical support posts to provide the appropriate height to support the plant. The horizontally interconnecting rods can be secured in place by a screw or other fastening device.

This invention relates to a plant support and more particularly, to improved ground supports for fruit, vegetables and other vegetation to support the weight of the various plant parts to sustain them during their growing period. It is contemplated that the support structure can also be used for non-plant support such as support of seasonal or holiday decorations.

### BACKGROUND OF THE INVENTION

It is common knowledge in the art that the control of certain parameters connected with the growth of plants can effectually control the growth, flavor, texture, aroma, quantity of output, configuration and shape of output, and any number of additional characteristics of the plant, its flowers, fruit or any other product a plant may produce. Likewise, it is considered desirable, if possible to suspend the fruit of a plant above the ground to decrease the incidence of spoilage and parasitic attack of the fruit, and in the case of flowers and foliage, to support the plant so that the flowers and/or foliage may provide a pleasing appearance and be easily accessible. Such elevation of plant parts also has the benefit of enhancing plant growth due to more of the plant surface being exposed to the atmosphere and a ready and constantly circulating supply of gaseous nutrients, and thereby also more effectively removing waste products. Additionally, there is evidence that movement of the plant, such as that induced by the wind blowing the plant about, is beneficial to plant growth by producing a greater robustness and strength in the plant.

In the past, numerous attempts to control the plant's physical environment have met with some degree of success, in some cases justifying the efforts required so that the method has become common practice. One such practice is the provision of a support for the plant so that as the plant grows it is possible to prevent the plant from lying directly on the ground. These supports generally take the form of stakes driven into the ground, circular wire meshes and the like, and are generally exceedingly simple structures often constructed of scrap materials and intended to last only one growing season. These structures often lack in durability, resulting in collapse of the support during the growing season, spoilage of the plant and/or its product and disposal problems thereafter.

Other attempts to provide desirable supports have resulted in supports that, although durable and intended to last through an indefinite number of growing seasons, have been either overly bulky in storage, expensive to manufacture and purchase, difficult to assemble, or failed in their intended purpose, that usually being to increase productivity of the plant. Moreover, current support systems do not allow the grower to tailor the support structure to their specific needs and desires as determined by the types of plants to be supported, the environment in which the plant is to be supported, and the personal tastes of the grower.

There is thus a need for an improved plant support that has the benefits of low cost, simplicity, ease of repair, ease of assembly, adjustable size, variable configuration, durability, compact storage, and effectiveness while having versatility in support structure designs to meet the specific needs of the grower.

### SUMMARY OF THE INVENTION

The present invention provides an adjustable plant support assembly that is an improvement over the prior art support structures. To this end, the present invention provides a plurality of upright members that form corners of a plant support having a polygonal shape. The upright members may be made of any material, including but not limited to re-bar, fiberglass, wood, metals, or other materials. The upright members may be interconnected by a plurality of horizontally aligned polygonal shaped adjustable, fixed or removable supporting rods. The horizontal rods may be joined at the corners and contain an aperture to allow the horizontal rods to pass through and attach to the upright members. The horizontal rods can be secured to the upright members by a fastener such as screw bolt, pin or similar, passing through the aperture.

Moreover, while the present invention may be a stand-alone plant support, the present invention further contemplates a plant support matrix comprising a plurality of plant supports of the above construction coupled together to form a complex plant support matrix, such as for example, to support an entire row of plants in a garden, provide support for an artistically arranged flower garden, lawn planting, young or mature trees, or grape vines. Additionally it is contemplated that the support assembly could be used to hang outdoor holiday or seasonal decorations.

Accordingly, several objects and advantages of the invention are the creation of an open area around the plant to make harvesting the fruit easier, tapered tips to assist in staking the structure to the ground, enhanced durability, easy disassembly and compact storage, as well as the ability to be scaled up or down to help support plants of various sizes. Additionally, the invention allows the user to utilize the support structures in multiple configurations, thus adding to the utility of the support.

By virtue of the foregoing, there is thus provided a plant support that is low cost, simple, easy to repair, easy to assemble, variably configurable, durable, effective in enhancing plant production and versatile so as to allow the grower to design the plant support to meet his/her needs and desires. These and other advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with the general description of the invention given above and the detailed description of the embodiments given below, serve to explain the present invention.

FIG. 1 is a perspective view of a plant support in accordance with the present invention;

FIG. 2 is a top view of the support in FIG. 1; and,

FIG. 3 is an angled view of the plant support as shown in FIGS. 1-2.

### DETAILED DESCRIPTION

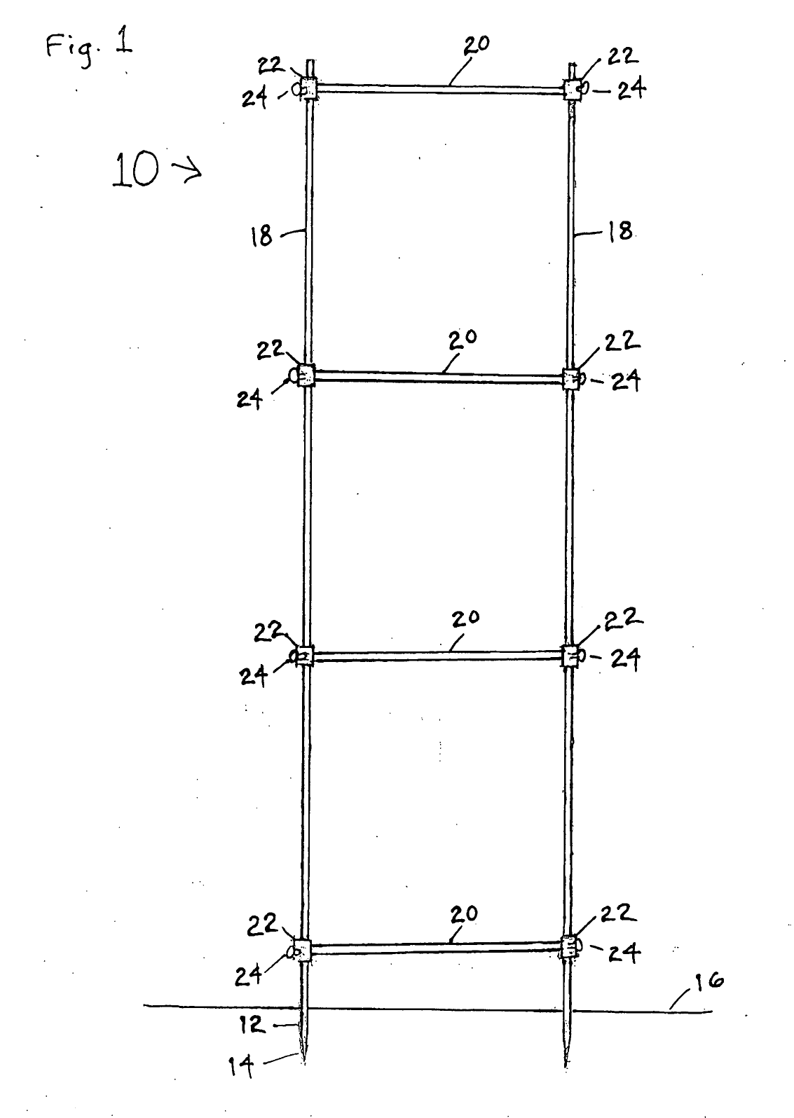

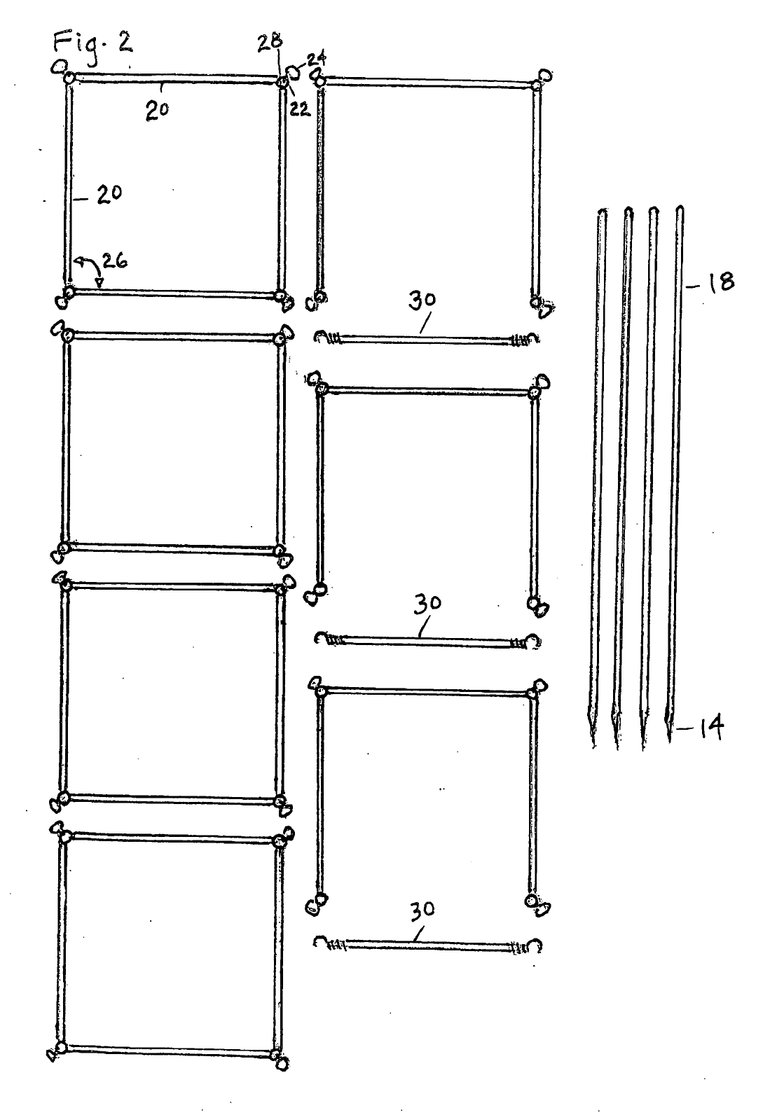

With reference to FIGS. 1-2, there is shown a preferred embodiment of a rectangular plant support 10 in accordance with the present invention. When erected as in FIG. 1, the plant support structure 10 provides for containing a plant within the framework of the structure and may also provide support for the limbs, branches etc. of a plant as it grows. The plant support 10 includes upright members 12 each having a bottom portion 14 that contains a pointed end 14 coupled to a surface 16 which, for example could be the ground or the floor of one's home or patio, and a top portion 18 vertically or nearly vertically extending away from the surface 16. The upright members 12 form the corners 22 of a plant support having a polygonal shape (FIG. 2). The upright members 12 are interconnected by a plurality of fixed or removable horizontal connecting rods 20, each horizontal connecting rod 20 having an elongate body terminating in an open tubing 28 which is connected to another horizontal connecting rod 20 at an appropriate angle 26 to form the horizontal polygonal shape (FIG. 2).

More particularly, the horizontal connecting rods 20 are joined together at the appropriate angle 26 by open tubing 28 that allows the upright members 12 to pass through and be driven into the ground 16, or alternatively, may be configured to stand on top of a solid floor such as the floor of a greenhouse or patio. Advantageously, upright members 12 and the horizontal connecting rods 20 are made from rebar but may also be made from wood, plastic or other suitable material of sufficient strength. Additionally, upright members 12 are advantageously round in cross section though the invention is not so limited.

The horizontal connecting rods 20 are secured to the upright members 12 by a screw 24 or other fastening device that is tightened through the open tubing 28 and against the upright members 12. The horizontal connecting rods 20 may be moved vertically along the upright members 12 to accommodate the preference of the user and provide the necessary support to the plant either at first use or during growth. Once in place the horizontal connecting rods 20 are secured by a screw 24 or other fastening device.

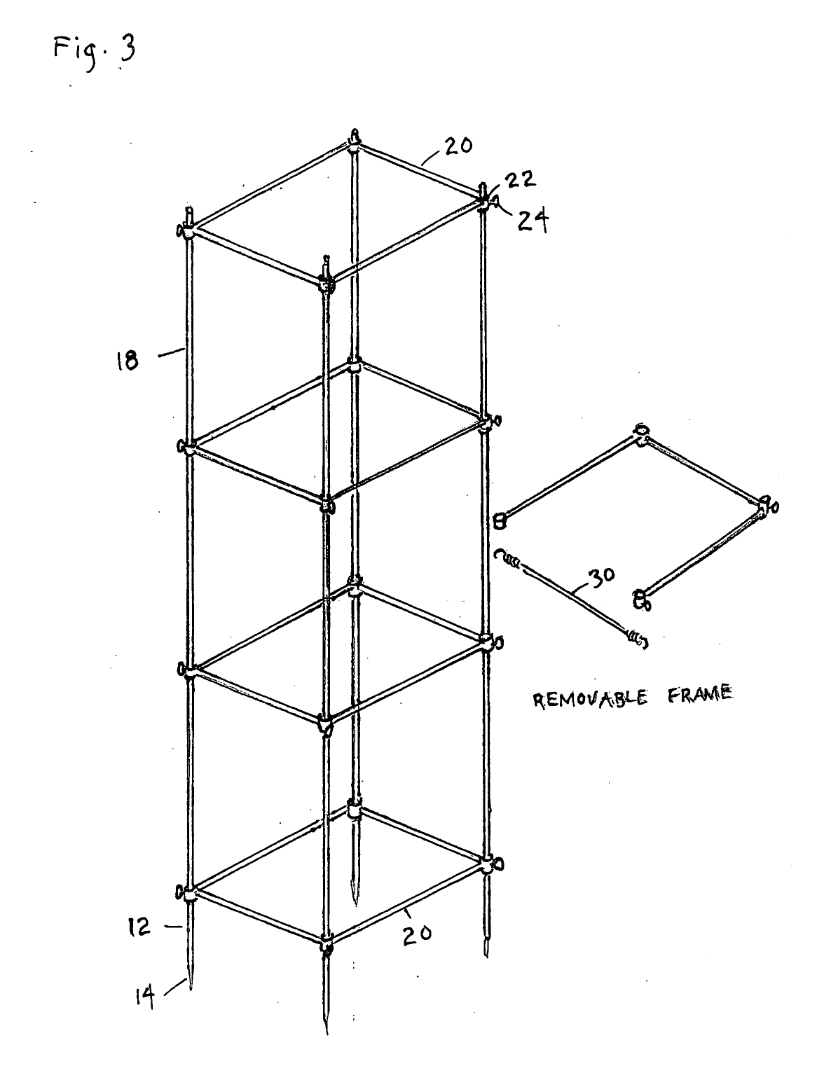

FIG. 3 shows a three dimensional orientation of a preferred embodiment of a rectangular plant support 10. The plant support 10 includes upright members 12 each having a bottom portion which can penetrate the ground outdoors or indoors 16 or alternatively can be configured to stand on top of a solid floor such as the floor of a greenhouse or patio. The upright members 12 are intersected horizontally by horizontal connecting rods 20 which are movable vertically along the upright members 12 and are secured to the upright members 12 by a screw 24 or other fastening device tightened through the surface of the open tubing 28.

While the above description contains many specifics, these should not be construed as limitations on the scope of the invention, but rather as exemplifications of one or another preferred embodiment thereof. Many other variations are possible, which would be obvious to one skilled in the art. Accordingly, the scope of the invention should be determined by the scope of the appended claims and their equivalents, and not just by the embodiments.

What is claimed is:

1. A supporting structure comprising:
a plurality of vertical supports in the form of elongated rods disposed at the corners of a polygonal shape;
a plurality of intersecting fixed or removable adjustable horizontal supports in the form of elongated rods connected together at an angle that matches the angles formed by the polygonal shape of said vertical supports;
said horizontal supports connected at said angle by an aperture that allows said vertical supports to pass through said aperture;
a fastening mechanism that when engaged said horizontal supports are fastened to said vertical supports and when disengaged allows said horizontal supports to move freely in a vertical plane along said vertical supports.

2. A structure as in claim 1 wherein said vertical and horizontal supports comprise metal posts.

3. A structure as in claim 1 wherein said angle is in the range of 85 to 95 degrees.

4. A structure as in claim 1 wherein said supporting structure is for supporting plant or vegetation growth.

5. A structure as in claim 1 wherein said supporting structure is used for supporting holiday or seasonal decorations.

6. A structure as in claim 1 wherein said fastening mechanism is a screw.

7. A structure as in claim 1 wherein said apertures comprise metal pipe.

8. A supporting structure comprising:
four vertical supports in the form of elongated rods disposed at the corners of a rectangular shape;
a range of 3 to 4 intersecting horizontal supports in the form of elongated rods connected together at an angle that matches the angles formed by the rectangular shape of said vertical supports to form a perpendicular vertical and horizontal intersection;
said horizontal supports connected at said angle by an aperture that allows said vertical supports to pass through said aperture;
a fastening mechanism that when engaged said horizontal supports are fastened to said vertical supports and when disengaged allows said horizontal supports to move freely in a vertical plane along said vertical supports.

9. A structure as in claim 8 wherein said vertical and horizontal supports comprise metal posts.

10. A structure as in claim 8 wherein said angle is in the range of 85 to 95 degrees.

11. A structure as in claim 8 wherein said supporting structure is for supporting plant or vegetation growth.

12. A structure as in claim 8 wherein said supporting structure is used for supporting holiday or seasonal decorations.

13. A structure as in claim 8 wherein said fastening mechanism is a screw.

14. A structure as in claim 8 wherein said apertures comprise metal pipe.

15. A supporting structure comprising:
four vertical supports in the form of elongated rods disposed at the corners of a rectangular shape, the bottom of said supports being tapered to allow for ground penetration;
a range of 3 to 4 intersecting horizontal supports in the form of elongated rods connected together at an angle that matches the angles formed by the rectangular shape of said vertical supports to form a perpendicular vertical and horizontal intersection;
said horizontal supports connected at said angle by an aperture that allows said vertical supports to pass through said aperture;
a fastening mechanism comprised of a screw mounted through said aperture that when engaged said horizontal supports are fastened to said vertical supports and when disengaged allows said horizontal supports to move freely in a vertical plane along said vertical supports.

16. A structure as in claim 15 wherein said vertical and horizontal supports comprise metal posts.

17. A structure as in claim 15 wherein said angle is in the range of 85 to 95 degrees.

18. A structure as in claim 15 wherein said supporting structure is for supporting plant or vegetation growth.

19. A structure as in claim 15 wherein said supporting structure is used for supporting holiday or seasonal decorations.

20. A structure as in claim 8 wherein said apertures comprise metal pipe.
